(19) United States
(12) Patent Application Publication
(10) Pub. No.: US 2008/0169145 A1
(43) Pub. Date: Jul. 17, 2008

(54) Device indicating the economic driving of a motor vehicle associated with the vehicle's acceleration system and increasing the mechanic resistance perceived by the driver on the accelerator pedal when preset position is achieved

(76) Inventor: Manuel Ibarra del Real, Vitacura (CL)

Correspondence Address: GOTTLIEB RACKMAN & REISMAN PC, 270 MADISON AVENUE, 8TH FLOOR, NEW YORK, NY, 10016-0601, US

(21) Appl. No.: 12/008,624

(22) Filed: Jan. 11, 2008

(30) Foreign Application Priority Data
Jan. 15, 2007 (CL) CL 102-2007

(51) Int. Cl. B60K 31/00

(52) U.S. Cl. 180/170

(57) ABSTRACT

The indicating device for the economic driving of a motor vehicle is associated with the vehicle's acceleration system, increasing the mechanic resistance perceived by the driver on the accelerator pedal, when a preset acceleration position is achieved. The mechanic resistance means are in the way of the linear or angular displacement stroke of any sections of the vehicle's acceleration mechanic subsystem. In addition the indicating device may have electric switching means interposed in the conventional electric turning-on system of the vehicle's air conditioning when reaching the preset acceleration position and with the compressor being automatically reconnected when the accelerator pedal is below the preset acceleration position.

The present invention refers to an indicating device for the economic driving of a motor vehicle and more in particular, the present invention mainly offers a device associated with the vehicle's accelerating system, which causes a light mechanic resistance on the acceleration pedal when exceeding a preset position. Secondarily and optionally, the device of the present invention may include means to turn off and turn on automatically the vehicle's air conditioning compressor system every time the present acceleration level is exceeded.

Both for safety policies at driving and fuel-saving policies, it is desirable that the drivers of motor vehicles keep aware of the way they use the accelerator in order to avoid sudden accelerations and high speeds.

Devices are already known that emit sound or visible warnings when the driver exceeds a preset speed. A kind of those devices measures the engine revolutions by counting the ignition cycle rate and when a preset value for the engine revolutions is achieved, an alarm turns on. These engine revolutions relate to the speed developed by the vehicle according to the operating gear at that time. The drawback of these systems is that they are effective only for high speeds. In addition, all these systems emitting alarm warnings may be very indirect as to reach the driver's attention field effectively. Warning audible signals in fact may not draw the attention of the driver if he/she is aware of other sounds (music or conversation for example) and visible warning signals may not be perceived if they are not within the driver's visual field.

Other devices of the prior art detect the position of the speedometer needle, but they are not accurate.

Even another kind of devices act by directly controlling the feeding and/or ignition of the engine, independently from the driver, when the engine achieves preset mixing consumptions rates.

The present invention, on the contrary, does not act over the engine or modify any operation parameter whatsoever as related to the vehicle's running. Also, although the invention's most representative embodiment produces a warning “signal” to the driver, such signal is not alien to the interaction with the accelerator, because it is precisely on the accelerator pedal where the driver notices the signal, expressed as a greater mechanic resistance therefrom when the pedal is pressed against a preset position; this, however, does not prevent continuing accelerating if the driver decides to ignore the warning. To this effect, the present invention provides mechanic resistance means offering a light mechanic resistance to the linear or angular displacement of any section of the mechanic subsystem of the vehicle's acceleration, when the accelerator pedal reaches a preset position. For these purposes, the mechanic resistance means are located in such a way that they put in the way of projections jointly installed in any of the sections of the vehicle's acceleration mechanic subsystem.

According to the above, the device of the present invention is not restricted to be located in the accelerator pedal itself, thus being arranged to be intervened any time along the vehicle's acceleration mechanic subsystem; this allows reducing the risks for the pedal to get stuck when devices are installed which are very directly related to it.

In a second embodiment of the invention, the device also provides means to save the energy used by the air conditioning system, when the accelerator exceeds a preset position. Basically, this energy saving device consists in an electrical switch that turns off the compressor of the vehicle's cabin air conditioning system automatically, while the accelerator pedal is pressed over a preset position; the compressor is turned off automatically again when the acceleration pedal is below the preset position. The intervention of this extra function to save energy automatically may be turned on or off at discretion by a switch.

One of the advantages of this energy saving device is especially appreciated when applied to low power vehicles, since usually this kind of vehicles are not able to respond to acceleration requirements well when its air conditioning system is operating. With this second embodiment for the invention device, all the capacity of the engine is destined to acceleration when it exceeds the preset level.

Another advantage of the present invention, unlike the prior art systems automatically intervening in the speed control, results from the fact that in this invention only a hard not no notice warning is emitted to the driver without intervening in the acceleration control; thus, if for instance the driver requires to overtake another vehicle, there is nothing preventing him/her accelerating over the preset level.

Even another advantage resulting from the present invention consists in the facility to emit an electric signal when the preset level for the critical position of the accelerator pedal is reached, so that such signal may be included in the digital microprocessor monitoring system most of the current modern vehicles have. Thus, for the manufacturer of vehicles adopting this invention would be easy to include into its monitoring system a recording control for the moment, frequency and duration of every event consisting in driving above the preset levels for economic driving. The emission of such electric signal may be as easily implemented as installing an electric switch turned on through the mechanic resistance means that linearly or angularly oppose to any section of vehicle's acceleration mechanic subsystem.

For a better understanding of the invention, detailed explanation thereof will be provided on the basis of illustrative examples, although not limiting and with the aid of drawings, where:

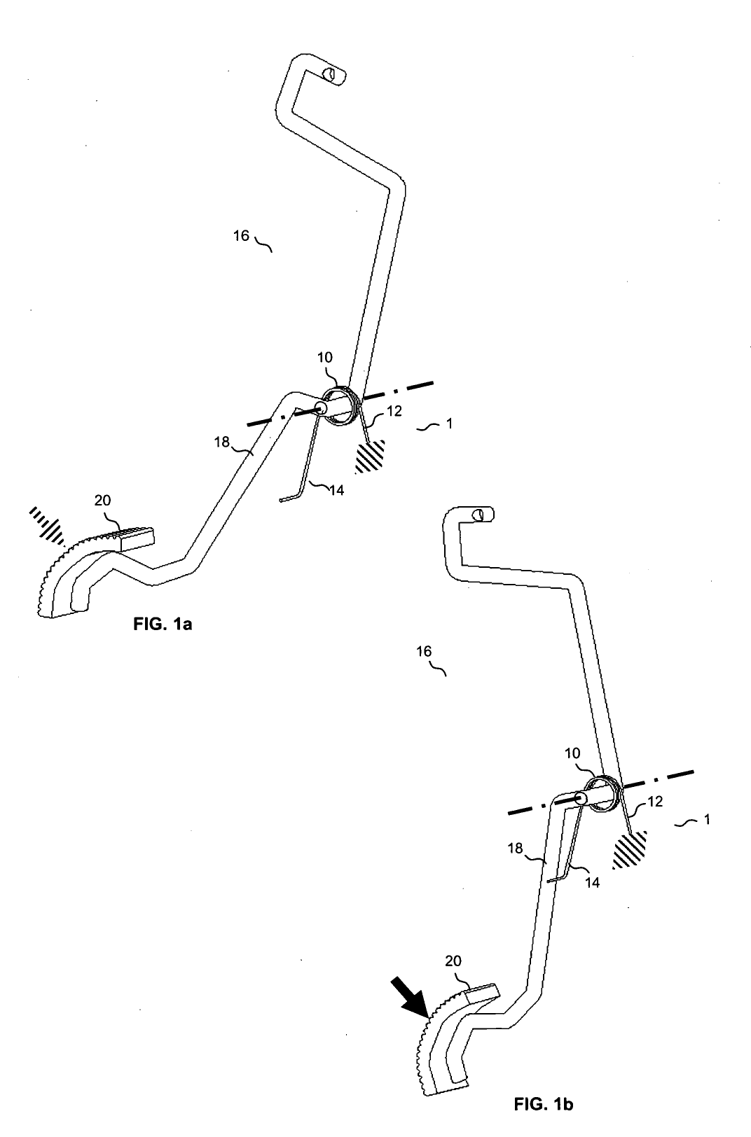

FIG. 1a and FIG. 1b show a scheme for carrying out a first embodiment of the invention, where a first kind of mechanic resistance is depicted in its two corresponding operation conditions;

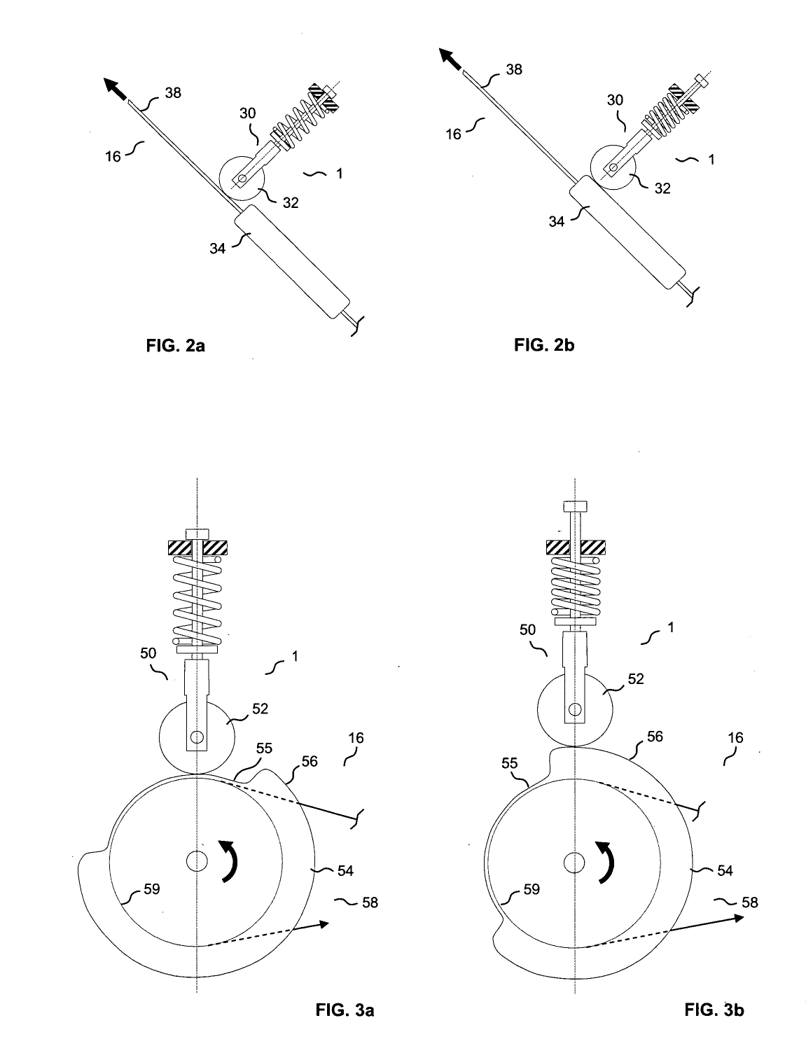

FIG. 2a and FIG. 2b show a scheme for carrying out a first embodiment of the invention, where a second kind of mechanic resistance is depicted in its two corresponding operation conditions;

FIG. 3a and FIG. 3b show a scheme for carrying out a first embodiment of the invention, where a third kind of mechanic resistance is depicted in its two corresponding operation conditions;

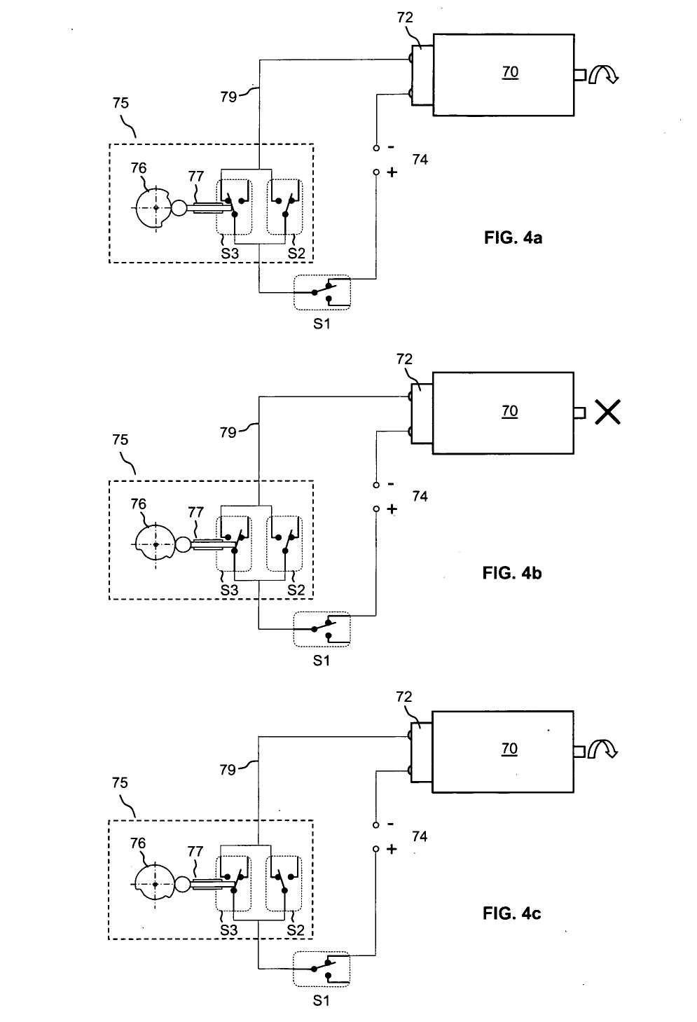

FIG. 4a-FIG. 4c show a scheme for carrying out a second embodiment of the invention, including means to save the energy used in the vehicle's air conditioning system in its three corresponding operation conditions; and

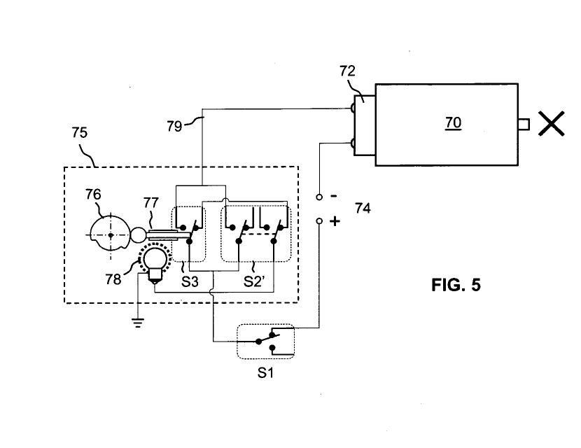

FIG. 5 shows a variant of the second embodiment of FIG. 4a-FIG. 4c where an additional connection is included for an indicator of the automatic turning off of the air conditioning compressor.

The first embodiment of the invention device consists in incorporating means offering a light mechanic resistance to the linear or angular displacement of any section of the vehicle's acceleration mechanic subsystem, which starts in the acceleration pedal and ends with the actuators controlling the fuel mixing (generally a butterfly valve both in the mixing system with carburetor and in the mixing system with injectors), so that these mechanic resistance means are interposed in a preset interval of the angular stroke (or linear as applicable) of said section. Through this, the driver experiences increased resistance in the accelerator pedal as warning and he/she has to increase the force applied over the accelerator if trying to accelerate over the preset level, or—if he/she obeys the warning—releases the foot pressure on the accelerator pedal.

In FIG. 1a and FIG. 1b, the first embodiment of the invention's device is shown, where the mechanic resistance means 1 consist in a tension spring 10 having a fixed arm 12 and a free arm 14, with this free arm 14 transmitting the load to the spring when deflected. The tension spring 10 is stationarily mounted on the surrounding structure, close to one of the sections or angularly moving rods 18 of the acceleration mechanism 16; thus the free arm 14 interposes in a preset position of the angular stroke of the section or rod 18 of the acceleration mechanism 16.

When the accelerator pedal 20 is in a position between its inactive position (accelerator pedal not pressed) and a preset acceleration position (FIG. 1a), the section or rod 18 of the acceleration mechanism 16 does not get in touch with the free arm 14 of the tension spring 10 yet which is in the way of the angular stroke thereof.

When the accelerator pedal 20 is pressed until reaching the preset acceleration position (FIG. 1b), the section or rod 18 makes contact with the free arm 14 of the tension spring 10 and it starts loading (or overloading) the spring. It should be noted that the spring 10 may be installed preloaded and with its free arm kept in position through a stop, so that to avoid the unloading of the spring. From this position of acceleration pedal 20, the user or driver feels resistance when pressing the pedal, which will increase if the accelerator continues being pressed above the preset level.

It should be obvious that when implementing the first embodiment of the invention, the mechanic resistance means may be different from the tension spring 10, and they may be for instance a traction spring, compression springs or other kinds of spring, arranged in such a way that they are mechanically loaded when the accelerator pedal exceeds the preset level.

In FIG. 2a, FIG. 2b, FIG. 3a and FIG. 3b the first embodiment of the invention device is shown, where the mechanic resistance means 1 consist in plunger-type followers (although they may be of the lever type too), as those used in mechanic devices with cams associated with a recoil spring. The plunger-type followers 30 may be used when the device of the present invention is installed in a displacement section which is substantially axial to the acceleration mechanic subsystem 16. Similarly, the plunger-type followers 50 may be used when the device of the present invention is installed in a displacement section substantially angular to the acceleration mechanic subsystem 16.

In FIG. 2a and FIG. 2b, the first embodiment of the invention is illustrated with the mechanic resistance means 1 configured as plunger-type followers 30. In this case, a moving section 38 of the acceleration mechanism 16 has been sketched, which has a substantially axial displacement when the acceleration pedal (not illustrated herein) is pressed. The moving section 38 has a portion of substantially uniform longitudinal widening 34, which may be shaped in the moving section 38 or may consist for instance in a cylindrical portion fixed in such moving section through bolts.

The plunger-type followers 30 are stationarily mounted on the surrounding structure close to one of the parts or moving sections 38 of the acceleration mechanism 16 and in such a way that its wheel 32 is placed in a preset position of the longitudinal stroke of section 38 of the acceleration mechanism 16. Since the plunger-type followers are known, a non-restricted example has been sketched, without further details of its structure. In this type of followers it should be enough to consider that the wheel 32 is revolvingly mounted on a stem associated with a compression spring, which is loaded when the wheel 32 departs from section 38 and is axially displaced in the stem direction.

As shown by FIG. 2a, the plunger-type followers 30 are installed in relation to the longitudinal widening 34, so that when the acceleration pedal is inactive or in a position prior to the preset position, the wheel 32 of the plunger-type followers 30 is in front of a point of section 38 before the start of the longitudinal stroke of longitudinal widening 34 and to a certain distance of such smaller section than the distance in which the longitudinal widening 34 projects radially. In this way, while the accelerator pedal is pressed below the preset acceleration level, section 38 of the acceleration mechanism 16 is longitudinally displaced approaching its longitudinal widening to the wheel 32, but without this interacting with such projection. When the preset acceleration level is reached, the wheel 32 is intercepted by the longitudinal widening 34, through which the wheel 32 will mount on the widening as shown in FIG. 2b, compressing the spring of followers 30. At the time the wheel 32 faces the longitudinal widening 34, the driver must apply greater force on the accelerator pedal if he/she wishes to ignore the warning produced from increasing the mechanic resistance generated by the spring load of followers 30.

Unlike the embodiment described in relation to FIG. 1, where mechanic resistance means 1 were used that loaded to a spring little by little while the (angular) displacement of the acceleration mechanism section 1 increased, under the current embodiment only the spring of the mechanic resistance means 1 is loaded while the wheel 32 changes its level in its longitudinal displacement in relation to the plunger, which translates in the driver only feeling resistance to continuing acceleration just for a brief moment, while the wheel changes the level between section 38 and the longitudinal widening 34 and not in a somewhat longer period of time as in the first embodiment.

In FIG. 3a and FIG. 3b the first embodiment of the invention is illustrated with the mechanic resistance means 1 configured as plunger-type followers 50 associated with angular displacements in a section of the acceleration mechanism section 16. In this case, an angularly moving section 58 of the acceleration mechanism 16 has been sketched having an angular displacement when the acceleration pedal (not illustrated) is pressed. This portion of the angular displacement has been exemplified in the farthest mechanic end of the acceleration mechanism pedal 16, made up by in this case by the pulley 59 vehicles usually have to command the butterfly valve of the mixing and feeding system.

Above the pulley 59 a joint cam 54 has been installed, which cam profile substantially consists in two sectors of different radius: one sector with a smaller radius 55 and the complementary sector with a greater radius 56. Like the embodiment of FIG. 2a and FIG. 2b, but in a version of angular displacement instead of linear, the plunger-type followers 50 are stationarely mounted on the surrounding structure close to one of the moving parts or sections 58 of the acceleration mechanism 16, as in the case of pulley 59, and so that its wheel 52 is placed in a preset position of the angular stroke of cam 54 placed jointly with the pulley 59 of the acceleration mechanism 59.

As shown in FIG. 3a, the plunger-type followers 50 are installed in relation to the greater radius sector 56 of cam 54, so that when the acceleration pedal is not pressed or is in a position prior to the preset position, the wheel 52 of the plunger-type followers is in front of a point of the sector of smaller radius 55 of cam 54, at a radial distance from the sector of smaller radius lower than the radial distance projecting from the smaller radius sector 56. Thus, while the accelerator pedal is pressed below the preset acceleration level, cam 54 which is jointly mounted to pulley 59 of the acceleration mechanism 16 is angularly displaced moving its greater radius sector 56 closer to the wheel 52, but without this interacting with such greater radius sector 56. When reaching the preset level of acceleration, the wheel 52 is intercepted by the greater radius sector 56, through which the wheel 52 will mount over the same sector as shown in FIG. 3b, thus compressing the spring of followers 50. When the wheel 52 faces the greater radius sector 56, the driver should apply a greater force on the accelerator pedal—if he/she wishes to ignore the warning—in order to overcome the obstacle made up by the aforementioned greater radius sector 56 and by the spring load of followers 50.

Like the embodiment described in relation to FIG. 2a and FIG. 2b, under the current embodiment only the spring of the mechanic resistance means 1 is loaded, while the wheel 52 changes its level between the two sectors 55 and 56 of cam 54, which translated in the driver feeling resistance only to continue accelerating for a brief moment, while the wheel 52 changes its level.

It should be obvious that in any of the implementations of the first embodiment using plunger-type followers (30 or 50), these could be replaced with lever-type followers, which are also basic mechanic elements, as well as—in other contexts—tackles, winches, gear trains and other universal elements of machines.

The second modality of the invention consists in any of the implementations of the first modality (FIGS. 1a to 3b or its obvious variants) where in addition a simple system of electric switches or circuit breakers has been installed interposed in the electric turn-on system of the vehicle's air conditioning system, such as the compressor's magnetic clutch or in any other means usually employed to control the compressor of the vehicle's air conditioning system.

The FIG. 4a and FIG. 4b correspond to schematic views of this second embodiment, where the compressor 70 of the air conditioning system is controlled by the magnetic clutch 72 which is energized by a power source 74 and commanded by the switch S1 that turns on and off the air conditioning system at the driver's will. These components, e.g the compressor 70, the magnetic clutch 72 and the command switch S1, are those usually installed in any vehicle equipped with air conditioning system.

The current embodiment of the invention has been depicted inside a segmented rectangle 75; here, it can be noted that the feeding line 79 from the magnetic clutch 72 has been broken by switches S2 and S3 that are parallel connected each other.

The switch S2 corresponds to a switch installed in the vehicle cockpit allowing the driver to selecting a normal mode of driving, that is, without the intervention of the automatic turning-off system of the air conditioning system, or else, allowing the driver to selecting a driving mode with automatic turning-off of the air conditioning compressor operation 70, when the accelerator pedal is displaced above a preset level.

The driving mode with automatic turning-off of the compressor 70 is governed by the switch S3 commanded by the mechanic resistance means described in the embodiments of FIG. 1 through 3. Although this description supported on FIGS. 4a-4c shows the mechanic resistance means as made up by a cam 76 and a follower 77, it should be obvious that the other embodiments described before may be easily associated with switch S3, so that the latter may drive or break the electric current that should be flowing through line 79. The switch S3 is in charge of turning on and off the compressor 70 automatically.

FIG. 4a shows this embodiment of the invention when driving with automatic turning-off of the compressor's operation 70 is selected, which is achieved commanding the switch S2 to place in its position of electric turning-off and so that the single way available remaining to energize the magnetic clutch 72 of compressor 70 is through switch S3. In this situation, the switch S3 is normally closed, that is, when the cam follower 70 does not act mechanically over it yet (because this is in contact with the smaller radius sector of the cam 76) the switch S3 drives electricity to line 79 and consequently, compressor 70 is active.

In FIG. 4b, like in the situation of FIG. 4a, driving with automatic turning-off of compressor's operation 70 is selected, because the switch S2 continues in the electric disconnection position selected by the driver, but it is shown that the cam 76 has angularly displaced in such a way that the follower 77 is now in contact with the greater radius sector of cam 76; this forces the follower stem to axially displace in order to push the switch S3 button and makes it to change its status, that is, S3 is placed on disconnections status, breaking the single way available to energize the magnetic clutch 72 through the line 79. This means that when the accelerator pedal (not illustrated) goes through the preset point of economic driving, the cam 76 turns to face follower 77 with its greater radius sector, with two effects been achieved: the already announced and described increase of mechanic resistance at the accelerator pedal (only when changing the cam's radius), and the turning-off of the electric power that commands the operation of the magnetic clutch 72 of compressor 70.

FIG. 4C shows a similar situation to that of FIG. 4b, but with switch S2 in the normal driving position, that is, with S2 placed on the electric connection position; through this line 79 is energized regardless of the connection or disconnection status of S3. In this situation, although the driver has decided to turn the compressor's automatic disconnection off, that is, he/she has decided to operate the compressor under any acceleration condition, this does not prevent the increase of mechanic resistance to be perceived on the accelerator pedal when this exceeds the preset level; thus the warning remains effective about ignoring it—accelerating—or obeying it, that is releasing the pressure of the foot on the accelerator pedal.

Although the present embodiment has been described as driven by a cam 76 and a follower 77 corresponding to the mechanic resistance means 1 of the embodiments described in relation to FIG. 2a to FIG. 3b, the present invention also considers that the automatic turning on and off of the air conditioning compressor is delayed as regards the moment where the accelerator pedal exceeds the preset position. It could be preferred that such compressor turning off occurs after the critical position is reached (which occurrence is always perceived by the driver as an increase of the mechanic resistance on the accelerator pedal).

For this phase displacement be carried out, in the case of embodiments with a spring—as the case depicted in FIG. 1a and FIG. 1b—installing the switch S3 in relation to the free arm 14 of the spring 10 is enough, in such a position that the S3's actuating button or lever is over the position of the follower when reaching the level change area.

For this phase displacement be carried out, in the case of embodiments with a spring, as is the case depicted in FIGS. 1a and FIG. 1b, installing switch S3 in relation to the free arm 14 of spring 10 is enough in such a position that the S3's actuating button or lever is over the critical position where the section or rod 18 of the acceleration mechanism 16 gets in touch with the free arm 14.

A variant of the second embodiment of the invention as described in relation to FIG. 4a and FIG. 4b with or without the phase displacement mentioned above, is depicted in FIG. 5 (corresponding to the equivalent situation of FIG. 4b), and this allows actuating a signaling device to warn that the air conditioning compressor has been automatically turned off, as the result of exceeding the preset level.

This variant consists in replacing the one-way two-position S2 switch with a two-way two-position switch S2′. The first of the S2′ ways is connected to the rest of components identically to the way already described in relation to such FIG. 4a and FIG. 4c, while the second way of S2′ is installed in such a way that its “inlet” or “common” terminal is connected to a terminal of a signaling device 78, as a lamp or other indicating device, and one of the “outlet” terminals is connected to the S3 outlet terminal, which was not connected to any point of the circuit in the previously described embodiment. The “outlet” terminal of the second way of S2′ connected to S3 is that switched to the driving mode when the first way is switched to the non-driving mode.

Thus, when the switch S1 is placed on air conditioning turning on and S2′ is placed on “economic driving” mode—this implying allowing the automatic disconnection of the air conditioning compressor when the a preset level is exceeded in actuating the accelerator pedal—the first way of S2′ is in the non-driving position of direct current to the compressor, and the second way is in the driving position (to the signaling device 78). But this second way is connected under a “conjunctive” mode (as an AND gate) to S3, so that the signaling device 78 will be only energized when such second way of S2′ is in the driving mode and when S3 in the non-driving mode of current to the compressor, since it is shifting the energy to the second way of S2′ and through this to the signaling device 78.

1. An indicating device for the economic driving of a motor vehicle associated with the vehicle's acceleration system and which increases the mechanic resistance perceived by the driver on the accelerator pedal, when a preset acceleration position is achieved, WHEREIN such device comprises:
mechanic resistance means offering a slight mechanic resistance to the linear or angular displacement of any sections of the vehicle's acceleration mechanic subsystem when the accelerator pedal reaches a preset position, with such mechanic resistance means being stationarely installed and in respect of which the moving sections of the vehicle's acceleration subsystem move when the vehicle's acceleration pedal is pressed;
such mechanic resistance means are in the way of linear or angular displacement stroke of any section of the vehicle's acceleration mechanic subsystem, thus defining a preset acceleration position.

2. The device of claim 1, WHEREIN such mechanic resistance means consist in a tension spring and such section of such acceleration subsystem is one of the sections or rods that move angularly, with one of its arms or branches of such spring being fixed and the other arm of such spring being in such a position that it is in the way of the angular stroke of such section or rod in such acceleration preset position.

3. The device of claim 1, WHEREIN such mechanic resistance means consist in plunger-type or lever-type followers associated with a recoil spring such as those used in mechanic devices with cams; with such followers being stationarely installed and arranged in an operating relationship with a projection or widening, which is jointly installed in a substantially axial displacement section of the mechanic acceleration subsystem, so that such followers get in touch with such projection or widening when reaching such preset acceleration position.

4. The device of claim 3, WHEREIN such projection or widening consists in a substantially cylindrical projection or widening, that is coaxial to such section of substantially axial displacement.

5. The device of claim 1, WHEREIN such mechanic resistance means consist in plunger-type or lever-type followers associated with a recoil spring such as those used in mechanic devices with cams; with such followers being stationarely installed and arranged in an operating relationship with a cam, which is jointly installed to a section of angular displacement of the acceleration mechanic subsystem, and where the profile of such a cam has at least a first sector or smaller radius and an second sector of greater radius, so that such followers may get in touch with such sector of greater radius of such a cam when reaching such preset acceleration position.

6. The device of any of claims 1 to 5, WHEREIN it also includes electric switching means interposed in the conventional electric turning-on system of the vehicle's air conditioning, which usually includes a source of electric power, a compressor and a first turning on and off switch of air conditioning, where such electric switching means consist in a second switch and a third switch which are parallel connected each other, with such second switch being installed in the vehicle's cockpit so that allowing selection between the normal driving mode and a mode to automatically disconnect the air conditioning compressor when reaching such preset acceleration position; to this effect it is connected in such a way that it breaks or feeds the electric feeding to such compressor, with such third switch being commanded by such mechanic resistance means and connected in such a way that it turns on or off the electric feeding to such a compressor.

7. The device of claim 6, WHEREIN such third switch is commanded by such mechanic resistance means when reaching such acceleration preset position.

8. The device of claim 6, WHEREIN such third switch is commanded by such mechanic resistance means after reaching such acceleration preset position.

9. The device of any of claims 1 to 5, WHEREIN it also includes electric switching means interposed in the conventional electric turning-on system of the vehicle's air conditioning, which usually includes a source of electric power, a compressor and a first turning on and off switch of air conditioning, where such electric switching means consist in a second two-way two-position switch and a third switch which are parallel connected each other, with such second switch being installed in the vehicle's cockpit so that allowing selection between the normal driving mode and a mode to automatically disconnect the air conditioning compressor when reaching such preset acceleration position; to this effect a first way is connected in such a way that it breaks or feeds the electric feeding to such compressor, with such third switch being commanded by such mechanic resistance means and connected in such a way that in a certain position it turns on the electric feeding to such a compressor an din the other position it turns off the electric feeding to the signaling means.

10. The device of claim 9, WHEREIN such signaling means are of the luminous and/or sound type.

11. The device of claim 10, WHEREIN such third switch is commanded by such mechanic resistance means when reaching such acceleration preset position.

12. The device of claim 10, WHEREIN such third switch is commanded by such mechanic resistance means after reaching such acceleration preset position.
